(19) United States
(12) Patent Application Publication
(10) Pub. No.: US 2009/0305665 A1
(43) Pub. Date: Dec. 10, 2009

(54) METHOD OF IDENTIFYING A TRANSMITTING DEVICE

(76) Inventors: Irwin Oliver Kennedy, Londonderry (GB); Francis Joseph Mullany, Castleknock (IE); Milind Buddhikot, Manalapan, NJ (US); Florian Pivit, Dublin (IE); Patricia Scanlon, Portobello (IE)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 12/132,933

(22) Filed: Jun. 4, 2008

(51) Int. Cl. H04M 1/66

(52) U.S. Cl. 455/410

(57) ABSTRACT

An exemplary method of identifying a transmitting device includes receiving a signal. A discrete Fourier transform of at least one portion of the signal produces a plurality of frequencies that indicate at least one unique characteristic of the transmitting device. A determination is made whether the transmitting device is a known device based upon the plurality of frequencies.

### FIELD OF THE INVENTION

This invention generally relates to communication. More particularly, this invention relates to identifying a transmitting device.

### DESCRIPTION OF THE RELATED ART

There are a variety of different communication systems in use. Wireless communications have seen expansive growth in recent years. Cell phone communication systems, for example, include a number of base station transceivers (BSTs) strategically positioned to provide wireless communication coverage over a geographic area. Known identification techniques allow for effective communications between base stations and mobile stations (e.g., cell phones) within communication range of the base station.

More recently, it has become more likely that smaller coverage area cells will be used within the same geographic region of a macrocell serviced by a base station. Such pico cells or femto cells provide advantages in extending wireless communication coverage into homes, commercial buildings and public places, for example. Additionally, such smaller cells may actually enhance macro-cellular services in some circumstances. For example, the smaller coverage area of such a smaller cell can allow for a higher data rate to an end user, can improve battery life and off-load end users that are otherwise camped on the macrocell.

With the proliferation of such smaller cells, additional challenges arise. For example, each time that a mobile station moves between camping on a macrocell and camping on a femto cell, a location area update is required. Prior to a successful location update, the mobile station needs to be authenticated by the femto base station. Using traditional techniques introduces additional authentication traffic in the network. In some situations a large number of mobile stations within a macrocell may detect a large number of femto base stations within a short period of time. Each such detection introduces additional signaling traffic. In some instances, the additional signaling traffic may be regarded as a “signaling storm” that introduces a significant burden on the system.

Additionally, many femto cells will be privately configured and only allow specific mobile stations to obtain access. It follows that many of the location update signaling traffic will be wasted because the mobile station will not have permission to access the femto cell in any event.

Another challenge associated with using known identification techniques includes having the permanent identifier for an end-user device (i.e., the International Mobile Subscriber Identification (IMSI) Number) exchanged more often than is otherwise done. When the exchange of the IMSI occurs in plain text, the security and privacy features of the network are compromised.

Each femto cell must identify the mobile station before determining whether to grant access to the femto cell. Some identification of the mobile station is, therefore, necessary. Attempting to do this by obtaining the mobile station's IMSI has several drawbacks. For example, a mobile station typically uses a temporary mobile subscriber identification number (TMSI). The mobile station sends the TMSI to perform a location area update. If a femto base station already knows the IMSI corresponding to the received TMSI, the femto base station can identify the mobile station. If not, the femto base station must contact a node in the core network to resolve the mapping from the TMSI to the IMSI. This results in a large increase in signaling load on the network equipment that provides that mapping. Additionally, the TMSI is changed by the network periodically to protect privacy so that a previously stored mapping at a femto base station is not reliable because it becomes invalid over time.

In another possible technique, the femto base station spoofs an identity request message by the mobile switching center to the mobile station to obtain the IMSI. Directly receiving the IMSI allows the femto base station to accurately identify the mobile station. However, the IMSI is sent in plain text over the air under such circumstances and allows for it to be detected in an unwanted or undesirable manner.

Without a strategic technique for identifying mobile stations, the deployment of co-channel femto cells could lead to significant signaling storms and reduce the privacy and security mechanisms of a wireless communication network. It would be desirable to be able to identify mobile stations at femto base stations without such drawbacks.

Another identification approach is suggested in a document titled “Device Identification Via Analog Signal Fingerprinting: A Matched Filter Approach.” The authors indicate that variations in analog signals caused by hardware and manufacturing inconsistencies among devices allows for authenticating devices. That document discloses a matched filter approach. The authors of that document did not consider that technique in the context of any wireless communications.

### SUMMARY

An exemplary method of identifying a transmitting device includes receiving a signal. A discrete Fourier transform of at least one portion of the signal produces a plurality of frequencies that indicate at least one unique characteristic of the transmitting device. A determination is made whether the transmitting device is a known device based upon the plurality of frequencies.

The exemplary method takes advantage of the unique way in which each transmitting device introduces variations in a transmitted signal compared to other devices. Utilizing a Fourier transform of at least one portion of the signal allows for analyzing that portion of the signal to detect the unique characteristics of the transmitting device that become apparent from that portion of the signal. This allows for identifying the transmitting device in a unique manner.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an example communication system.

FIG. 2 is a flowchart diagram summarizing one example approach.

### DETAILED DESCRIPTION

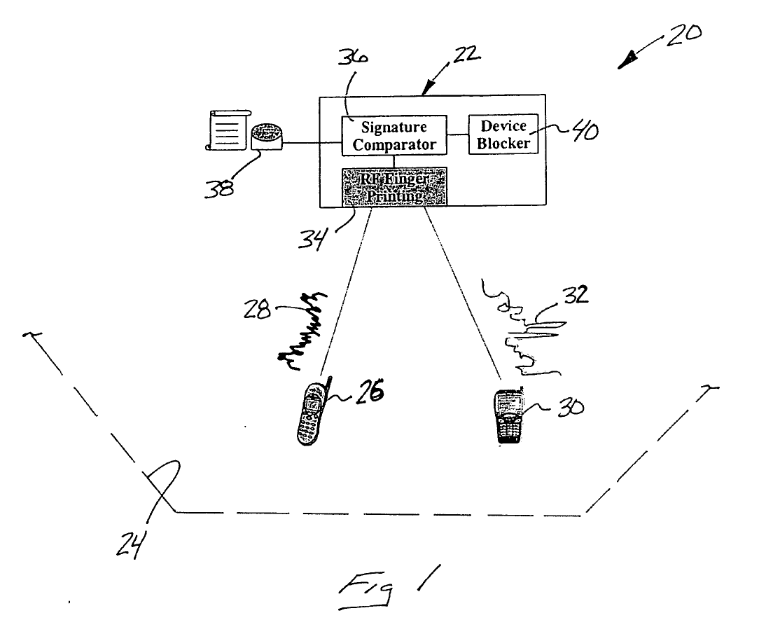

FIG. 1 schematically shows selected portions of a wireless communication system 20. In this example, an overlay base station device 22 such as a femto base station provides a relatively small area of communication coverage within a macrocell coverage area partially and schematically illustrated at 24 provided by an underlay base station transceiver. There is at least some overlap between the coverage area of the base station device 22 (e.g., a pico cell base station or a femto base station) and the macrocell coverage area 24. There also is some co-channel use between the two coverage areas.

In the example of FIG. 1 a mobile station 26 is close enough to the base station device 22 to be a candidate for camping on the corresponding cell of the base station 22. The mobile station 26 provides a signal 28 to the base station 22 that has a particular signature or radio frequency characteristic that is unique to the mobile station 26. The unique signature or characteristic of the signal from the mobile station 26 is based upon unique aspects of the hardware within the mobile station 26. As the signal is processed through the transmit path in the mobile station 26, a signal signature is introduced that is unique to the mobile station 26.

For example, the local oscillator within the mobile station 26 has an associated stability. The accuracy of the center frequency of the RF signal depends upon the stability of that local oscillator. Additionally, the noise level of the oscillator determines the noise level of the transmitted radio frequency signal.

Another component within a typical mobile station includes an amplifier whose linearity depends upon the particular implementation. Signal quality measures such as adjacent channel power or error vector magnitude are dependent upon the implementation of the amplifier.

Another example component within the mobile station potentially affecting the radio frequency signature is a filter. Filters vary between manufacturers and may vary from batch-to-batch of production.

Another feature that affects the signal signature is the board manufacturing quality that impacts the similarity between two identically specified boards at the radio frequency level. Component placement on a board, component tolerances, soldering material consistency and temperature variations all can influence the radio frequency performance of the final product. Such variations may occur from time-to-time at production facilities.

Any of the above features or components of a transmitting device provide a unique radio frequency signature that is utilized in a disclosed example embodiment of this invention for purposes of uniquely identifying a transmitting device based upon such a signature.

The example of FIG. 1 includes another mobile station 30 that transmits a signal 32 that is received by the base station device 22. As schematically illustrated in FIG. 1, the radio frequency signature of the signal 32 is different than that of the signal shown at 28.

The base station device 22 includes a radio frequency fingerprinting module 34 that obtains information regarding the unique characteristics of the signals transmitted by each of the devices 26 and 30. A signature comparator module 36 compares a determined signature with information in a data base 38 for purposes of attempting to identify a mobile station as one that is permitted access to the corresponding cell. A device blocker module 40 facilitates communications with the mobile stations to indicate whether it is authorized to communicate through the base station device 22 or if it is blocked from such access. If blocked, the mobile station continues communicating through the base station transceiver of the macrocell 24.

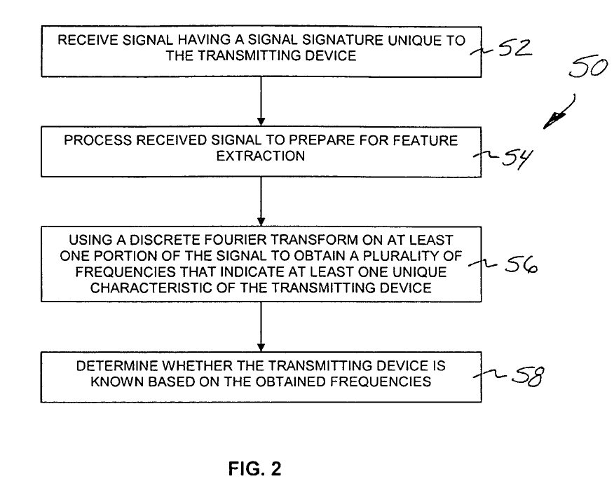

FIG. 2 includes a flow chart diagram 50 that schematically illustrates an example approach. At 52, a signal is received at the base station device 22. The signal has at least one portion that is used to determine the signal signature. The transmitting device may be identified if the signature is that of a known device. For discussion purposes, a portion of the signal with known content is used for identification. In one example, a portion of the signal comprises a random access channel (RACH) preamble. One example includes instructing all transmitting devices within range of the base station device 22 (e.g., all those within the macrocell 24) to transmit exactly the same RACH preamble sequence. That portion of a received signal, therefore, includes known content. Keeping the transmitted sequence identical among mobile stations simplifies the task of identifying characteristic differences between signals from the different mobile stations. Some example implementations do not require a portion of a signal having known content. Any portion of a received may be used to identify the transmitting device based on the signal signature.

In one example UMTS implementation, the scrambling codes and signatures used for the RACH preamble are restricted to a single combination. The broadcast channels transmitted by the base station that provides the macrocell coverage 24 contains the information that restricts the scrambling codes and signatures to that particular combination. In a mobile station within the corresponding geographic area receiving the broadcast message will responsively configure the RACH preamble to the selected content. In one example, the system information block 5 (SIB 5) is used to restrict the number of RACH scrambling codes and signatures that a mobile station may choose from for establishing the RACH preamble. This results in known content of that portion of the signal. In this example, the rack preamble is used for signature analysis and transmitter recognition.

At 54, the received signal is processed to prepare it for feature extraction. In one example, this processing includes digitizing and down sampling the received signal. After filtering, the amplitude of the time signal is normalized and any frequency offset between the mobile station and the base station 22 receive path is corrected. Once such steps are taken, using known techniques, feature extraction to identify the transmitting device begins.

In the example of FIG. 2, at 56 a discrete Fourier transform (DFT) is used on the selected portion of the signal having the known content (e.g., the RACH preamble) to obtain a plurality of frequencies that indicate at least one unique characteristic of the transmitting device. The discrete Fourier transform operates on the RACH preamble portion of the signal in this example to produce a Fourier spectrum with frequency values at a finite number of discrete frequencies. Discrete Fourier transform techniques are known.

One example includes sampling the signal at more than twice the highest frequency component. Such an example involves down-converting the received radio frequency signal and acquiring it at a sampling rate of 12.5 samples per second. This results in discrete Fourier transform components spanning a spectrum from 0 to 6.25 MHz.

The finite sampling of the signal results in a truncated waveform with discontinuities. The truncated waveform has different spectral characteristics from the original continuous-time signal. Smoothing windows are applied to improve the spectral characteristics of the sampled signal by minimizing the transition edges of the truncated waveforms. One example includes splitting the sample data from each RACH preamble into windowed overlapping time frames. This allows for extracting a finite sequence for transformation using a fast Fourier transform algorithm.

As a Fourier transform of a random waveform provides a random result, spectral averaging is used in one example to remove the effects of random noise and transient events to create a clearer picture of the signal's underlying frequency content. In one example, the time domain sample of each RACH preamble portion of a received signal is divided into overlapping windowed segments of samples. The segments are frequency transformed and the magnitudes of the resulting frequency are averaged to remove the effect of unwanted noise and to reduce random variants. The average power spectrum for each RACH preamble can then be used as input to the signature comparator module 36.

Once acquired, the data indicating the unique signal signature or characteristic of the transmitting device is used to determine whether the transmitting device is known at 58. In other words, the frequencies obtained from using the discrete Fourier transform on the RACH preamble portion of the signal are used for determining the radio frequency fingerprint or signature of the transmitting device for purposes of determining whether that device is a known or authorized device for communications with the base station device 22.

Determining whether the transmitting device is known in one example includes determining whether the transmitting device belongs to one of a known set of classes. The data base 38 in such an example includes information indicating what characteristics of a received signal fit within a particular class or classes of transmitting device. When the received signal characteristics corresponds sufficiently with one or more of the classes, the determination whether the device is a known or acceptable device is made depending on the class within which the device belongs.

One example includes using a nearest neighbor classification algorithm to determine which device the signal was acquired from. A nearest neighbor algorithm includes training samples that are mapped into multi-dimensional feature space that is partitioned into regions based on the class labels. The class of the device transmitting the received signal is predicted to be the class of the closest training sample using a Euclidean distance metric. Once the features are extracted for every sample in the training set, the mean and standard deviation is computed for normalization. Each feature dimension in the training set is separately scaled and shifted to have zero mean and unit variants. The same normalization parameters are then applied to the set of information from each received signal from a transmitting device during a process of attempting to identify a device.

One example includes utilizing a voting algorithm to provide a more robust classification technique. In such an example, the decision whether a mobile station is recognized or not is based upon the number of RACH preambles sent by the mobile station. The device blocker module 40 takes the output of the classifier (i.e., the signal comparator module 36) for each RACH preamble. The class having the most votes is considered to be the class in which the device belongs. Such an approach allows for compensating for noisy or corrupted RACH preamble data received by the base station device 22.

Being able to identify a mobile station as a member of a known class within the data base 38 allows for avoiding additional signaling between the base station device 22 and another portion of the network. If the signature comparator module 36 is not able to classify a particular mobile station RACH preamble with a high level of confidence, it is possible to solicit more RACH preamble signals from the mobile station. This occurs in one example by not responding to the RACH preamble at the base station device 22. In such a circumstance, the mobile station will retransmit the signal including the RACH preamble several times typically increasing transmit power along the way. This provides more RACH preamble information to the base station device 22, which may facilitate identifying the mobile station by reducing or minimizing the effect of noise associated with one or more RACH preambles that have been received.

Once the signature comparator module 36 is able to successfully identify a mobile station, a positive acknowledgement message (AICH) is sent to the mobile station. When the mobile station is not identified as a known or authorized device, a negative acknowledgement can be sent from the device blocker module 40 to the corresponding mobile station. Such a negative acknowledgement indicates that the device has been rejected and will not be allowed to camp on the cell of the base station device 22.

In some situations, a positive identification or classification of a transmitting device with a sufficiently high degree of confidence will not be possible based upon the RF signature or fingerprinting technique described above. In such a case, some examples include considering the TMSI or IMSI of the mobile station for purposes of attempting to admit it for communications with the base station device 22. One example includes spoofing a MSC or SGSN identity request to the mobile station. Another example includes obtaining the TMSI from the mobile station at the base station 22 and then signaling to the core network to obtain the mapping information between the TMSI and the IMSI of the mobile station.

Once a mobile station is positively accepted, the local area code update procedure occurs with the base station device 22 informing the core network. The mobile station resolves the TMSI-IMSI mapping by signaling the core network. Once confirmed with full confidence as belonging to the set of authorized transmitting devices, the mobile station is accepted by the base station device 22 and the core network is informed. If the mobile station is determined not to belong to an authorized set after querying the core network, the mobile station will be rejected.

The above described examples allow a pico or femto base station to rapidly detect end user transmitting devices without excessive interaction with the rest of the macrocell infrastructure. Each pico or femto base station is able to accept or reject a transmitting device based upon unique characteristics of a signal transmitted by that device.

One feature of the disclosed examples is that they operate on physical layer signals such that it does not affect higher layer protocols. There is no required modification to the standards used in the macrocells. Additionally, the disclosed examples do not require any changes to the mobile stations, themselves. The efficient deployment of the example techniques provide a significant reduction in the potential rise in signaling traffic introduced by the proliferation of overlay cells within the macrocell coverage area of an underlay network.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of identifying a transmitting device, comprising the steps of:
receiving a signal;
using a discrete Fourier transform of at least one portion of the signal to produce a plurality of frequencies that indicate at least one unique characteristic of a transmitting device; and
determining whether the transmitting device is a known device based on the plurality of frequencies.

2. The method of claim 1, wherein the transmitting device is a mobile station and the received signal is a wireless communication signal.

3. The method of claim 2, wherein the at least one portion of the signal comprises a random access channel preamble.

4. The method of claim 3, comprising
instructing all mobile stations within a vicinity of a base station to transmit the same random access channel preamble sequence such that the at least one portion has known content.

5. The method of claim 3, comprising
receiving a plurality of signals from the mobile station; and
using a corresponding plurality of the received at least one portions for determining whether the mobile station is a known device.

6. The method of claim 5, comprising one of
sending a positive acknowledgment message to the mobile station once it has been determined to be a known device; or
sending a negative acknowledgment message to the mobile station if it has not been determined to be a known device.

7. The method of claim 1, comprising
determining whether the plurality of frequencies indicate that the transmitting device is within at least one predetermined category; and
determining the transmitting device to be a known device if it is within the at least one category.

8. The method of claim 1, comprising
storing at least one set of frequencies corresponding to a known device; and
comparing the produced plurality of frequencies to the at least one stored set of frequencies; and
determining the transmitting device to be a known device if there is at least a selected level of correspondence between the produced plurality of frequencies and the stored set of frequencies.

9. The method of claim 1, comprising
dividing the produced plurality of frequencies into a plurality of overlapping windowed segments of samples;
frequency transforming each segment to provide a corresponding plurality of resultant frequencies;
determining an average of a magnitude of the resultant frequencies as a power spectrum indication of the received signal; and
using the power spectrum indication for determining whether the transmitting device is a known device.

10. The method of claim 1, comprising
determining whether the transmitting device is a known device by
determining a number of signals having the at least one portion received from the transmitting device that correspond to each of a plurality of predetermined categories; and
determining that the device belongs to the category having the highest number of signals.

11. The method of claim 1, comprising
obtaining at least one of an international mobile station identifier or a temporary mobile station identifier regarding the transmitting device if it is not possible to determine that the transmitting device is a known device based on the produced plurality of frequencies.

12. A base station device, comprising
a receiver for receiving a signal;
a fingerprinting module that uses a discrete Fourier transform of at least one portion of the signal to provide a plurality of frequencies that indicate at least one unique characteristic of a transmitting device; and
a signature comparator module that determines if the plurality of frequencies indicate a known transmittal device.

13. The device of claim 12, comprising a data base indicating known devices and wherein the signature comparator module determines if the plurality of frequencies correspond to information in the data base.

14. The device of claim 12, wherein the transmitting device is a mobile station and the received signal is a wireless communication signal.

15. The device of claim 14, wherein the at least one portion of the signal comprises a random access channel preamble having known content.
